(19) United States
(12) Patent Application Publication
(10) Pub. No.: US 2005/0232627 A1
(43) Pub. Date: Oct. 20, 2005

(54) Method and apparatus for optical performance monitoring

(76) Inventors: Fengguo Sun, Ottawa (CA); GaoZhi Xiao, Ottawa (CA); Zhenguo Lu, Ottawa (CA); Chander P. Grover, Ottawa (CA)

Correspondence Address: TEITELBAUM & MACLEAN, 1187 BANK STREET, SUITE 201, OTTAWA, ON, K1S 3X7, CA

(21) Appl. No.: 10/827,306

(22) Filed: Apr. 20, 2004

(51) Int. Cl. H04B 10/08

(52) U.S. Cl. 398/26

(57) ABSTRACT

Method and apparatus for real time measuring of an optical signal to noise ration (OSNR) of an optical channel is disclosed. The apparatus comprises a fiber Bragg grating for reflecting a signal component of the optical channel and for transmitting a noise component of the optical channel therethrough. Two photodetectors are provided disposed at two ends of the fiber Bragg grating for detecting a fraction of the reflected signal component and the transmitted noise component respectively. Electrical outputs of the photodetectors are communicated to a microprocessor for determining the OSNR. The invention provides a simple, compact, reliable, relatively fast and inexpensive technique to monitor OSNR.

### FIELD OF THE INVENTION

The present invention relates to performance monitoring of optical networks and specifically to monitoring of an optical signal to noise ratio in wavelength division multiplexed systems.

### BACKGROUND OF THE INVENTION

Fiber optic communication systems typically employ wavelength division multiplexing (WDM), which is a technique for using an optical fiber to carry many spectrally separated independent optical channels. In a wavelength domain, the optical channels are centered on separate channel wavelengths which in dense WDM (WDM) systems are typically spaced apart by 25, 50, 100 or 200 GHz. Information content carried by an optical channel is spread over a finite wavelength band, which is typically narrower than the spacing between channels.

Optical amplifiers such as erbium doped fiber amplifiers (EDFA) are used to amplify optical channels to compensate for fiber attenuation in long optical links and for other optical losses. However, EDFAs also add optical noise to an amplified WDM signal, which is associated with amplified spontaneous emission (ASE). In a spectral domain, the ASE noise is spread over a gain bandwidth of the EDFA and is superimposed on the wavelength bands of the optical channels. Power spectral density of the ASE noise is typically ˜10 to 30 dB lower than a peak power spectral density of a channel. Nevertheless, the ASE noise can severely limit information performance of an optical communication link, and lead to errors in signal detection, or an increased bit error rate (BER).

The BER of an optical channel depends on an Optical-Signal-to-Noise-Ratio (OSNR). OSNR and the channel power are affected by an accumulation of factors including insertion loss, polarization dependent loss, and amplifier gain of the various in-line components in the system. OSNR is one of the most important parameters determining DWDM system performance because of its dominance in determining BER. Two DWDM channels having the same optical power but different OSNR have a significant difference in BER. Consequently, OSNR is typically monitored at each receiver site in a DWDM system and the OSNR information is used to optimize performance.

An additional reason to monitor OSNR in a DWDM system is the use of Optical-Add/Drop-Multiplexors (OADM). Thy can inject a new signal onto an unused channel of the DWDM signal or swap a new signal for an old signal in a utilized channel. When the OADM drops a signal, it drops the noise associated with that signal, reducing the noise level of the overall multiplexed signal. In addition, the signal added may have a very different power and noise level from the signal dropped. A change in the power of a channel can degrade the OSNR of other channels and the substitute wavelength may not have the needed OSNR to carry traffic if injected into routes that do not have sufficient safety margin. Each of these difficulties can be compensated for if the OSNR characteristics are measured and used to assure that the appropriate power levels are supplied.

One difficulty in OSNR measurement in any optical system is the narrowness of the optical channel linewidth (span of wavelengths used to carry information), requiring a very high-resolution filter to distinguish the channel from the noise level. Conventional Optical Performance Monitors (OPM) have limited resolution when used in current systems, and thus can yield inaccurate OSNR measurement results and sub-optimum performance of the DWDM system. In a DWDM signal, there is an ASE noise floor above the zero power level determined by accumulated EDFA noise, and a set of channel peaks at regular frequency intervals. The OSNR for a signal channel is a ratio between a total signal channel power Ps measured within the channel signal bandwidth and the noise power Pₙₒᵢₛₑ measured in a fixed wavelength interval Δλ as expressed in Equation 1.
OSNR(Δλ)=Ps/Pₙₒᵢₛₑ (1)

Three devices have traditionally been used to perform optical power measurements: the optical spectrum analyzer (OSA), an optical grating plus a detector array analyzer and the filter analyzer. The optical spectrum analyzer is a piece of laboratory equipment, large, bulky and expensive. It accomplishes bandpass filtering or splitting of the signals using a diffraction grating to separate wavelengths, and a detector which measures the power in the wavelength that the signal has been broken into. The OSA can be highly accurate if enough time is allowed for enough energy to impinge on the detector. Because of the size, cost and time needed, it is not practical to utilize OSAs in a DWDM system.

The detector array analyzer uses a bulk grating and a detector array. This device satisfies the size and cost requirements for multiple deployments in a DWDM system, but has limitations as to resolution. The filter analyzer is based on a Fabry-Perot filter to determine the wavelength to be measured by the detector. If the spacing of the detector array is narrow enough, the difference between the noise and the channel can be measured. However, because the filter is designed to span multiple channels, the optical resolution is limited. Both the bulk grating and the Fabry-Perot filter can be made small and inexpensive enough to be used in multiple locations in a DWDM system, but they can only measure OSNR to 20 to 25 dB when the DWDM channel spacing is 50 GHz or less. This limitation results in a measurement error and the attendant system inefficiency.

Another approach to building an OSNR monitor is disclosed in U.S. Pat. No. 6,396,051 issued to Li et al. With reference to FIG. 1 (prior art), the OSNR monitor is first isolated from the main transmission path by an isolator 120. The optical signal passes through a narrow-band notch filter 122 and a tunable bandpass filter 124. Depending on whether the power in the channel or the noise is to be measured, a switch 126 directs the optical signal to either a first detector 128 or a second detector 130. The electrical outputs of the detectors are received by controller/processor 132 which cycles the tuning of the FGB filter 122, the tuning of the bandpass filter 124 and the setting of the switch 126 for further measurements across a frequency band of interest. A processor 132 receives the detector outputs, calculates the OSNR, and controls the tunable components.

Although the aforementioned inventions appear to perform their intended functions, they provide solutions requiring tunable and/or switching components, which are complex and can be rather expansive.

As the channel spacing decreases with increasing system capacity, it becomes more necessary to use the OSNR measurement. The best system performance can be realized by equalizing OSNR rather than power. With a built-in optical channel monitor, OSNR can be measured in real time in the system. For long-haul systems, the OPM facilitates balancing of the optical power to minimize the effects of fiber amplifier gain non-uniformity. In addition, as an increasing number of vendors and service providers come into the DWDM market, it is desirable to use equipment (such as transmitters, optical amplifiers, and receivers) from multiple vendors in the same DWDM system. A small and economical OPM provides a useful tool for system turn-up, operation and troubleshooting in such a mixed vendor environment. Consequently, there is a need for a small, economical high-resolution optical monitor that can be utilized and mounted with circuit boards within a DWDM system.

An object of this invention is to provide a simple, compact, relatively fast, reliable and cost effective method and apparatus to measure and monitor OSNR.

### SUMMARY OF THE INVENTION

In accordance with the invention, an apparatus is provided for measuring an optical signal to noise ratio (OSNR) for an optical channel radiation having a central wavelength λc and having a noise component having a noise bandwidth and a signal component having a signal bandwidth, said apparatus comprising: a a spectrally-selective reflecting element having a reflecting bandwidth disposed to receive the optical channel radiation for reflecting at least a portion of the signal component to form reflected radiation, and for transmitting at least a portion of the noise component to form transmitted radiation; a first optical detector disposed to receive at least a fraction of the reflected radiation for producing a first information signal indicative of the signal component; a second optical detector disposed to receive the transmitted radiation for producing a second information signal indicative of the noise component; optical coupling means for coupling the optical channel radiation into the spectrally-selective reflecting element, and for coupling at least a fraction of the reflected radiation into the first optical detector; processing means disposed to receive the first information signal indicative of the signal component and the second information signal indicative of the noise component for determining the optical signal to noise ratio.

In a preferred embodiment, the a spectrally-selective reflecting element is a fiber Bragg grating centered at the central wavelength λc of the optical channel, and having a reflection bandwidth which is smaller than the noise bandwidth and at least as great as the signal bandwidth.

In accordance with another aspect of this invention, a method is provided for determining the optical signal to noise ratio for an optical channel radiation having a central wavelength λ_{c} and having a noise component having a noise wavelength band and a signal component having a signal wavelength band wherein the signal wavelength band is narrower than the noise wavelength band, said method comprising steps of: a) providing a fiber grating disposed to receive the optical channel radiation for reflecting or deflecting the signal component out of the fiber grating to form a tapped radiation, and for transmitting at least a portion of the noise component therethrough to form a transmitted radiation, b) providing a first optical detector disposed to receive at least a fraction of the tapped radiation for producing a first electrical signal indicative of the signal component, c) providing a second optical detector disposed to receive at least a fraction of the transmitted radiation for producing a second electrical signal indicative of the noise component, d) providing optical coupling means for coupling the at least a fraction of the tapped radiation into the first optical detector, e) providing processing means disposed to receive the first electrical signal indicative of the signal component and the second electrical signal indicative of the noise component for determining the optical signal to noise ratio, f) launching a portion of the optical channel radiation into the fiber grating, and, g) determining the optical to signal ratio from the first information signal and the second information signal using the processing means.

In accordance with another embodiment of the invention, a method is provided for determining an optical signal to noise ratio of an optical channel of a WDM signal comprising a plurality of optical channels, said method comprising further comprising a step of first providing a wavelength de-multiplexer disposed to receive a fraction of the WDM signal for wavelength de-multiplexing of at least the optical channel from the plurality of optical channels.

### BRIEF DESCRIPTION OF THE DRAWINGS

Exemplary embodiments of the invention will now be described in conjunction with the drawings in which:

FIG. 1 is a diagram of a prior art OSNR monitor.

FIG. 2 is a diagram of an apparatus for measuring the OSNR of an optical channel according to instant invention.

FIG. 3 is a wavelength domain representation of a signal component and a noise component of an optical channel.

FIG. 4 is a diagram of an apparatus for measuring the OSNR comprising a blazed grating.

FIG. 5 is a diagram of an apparatus for measuring the OSNR for a WDM signal.

FIG. 6 is a diagram of an apparatus for measuring the OSNR and equalizing optical channels of a WDM signal.

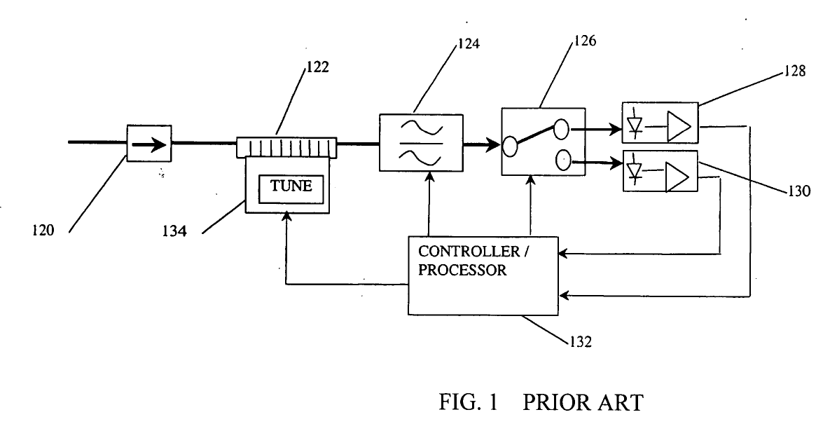

### DETAILED DESCRIPTION OF THE PREFERRED EMBODIMENT

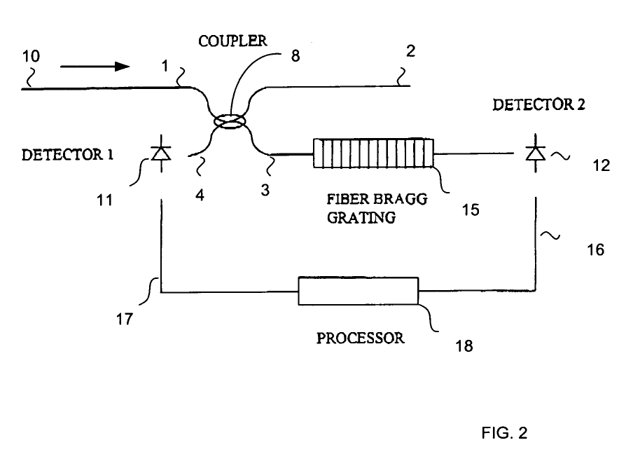

A preferred embodiment of an apparatus for measuring a signal to noise ratio (OSNR) for an optical channel is shown in FIG. 2 and is hereafter described.

An input port of a fiber Bragg grating 15 is connected to a third optical port 3 of a four-port optical coupler 8. An optical port of a first optical detector 11 is optically coupled to a forth port 4 of the optical coupler 8. An optical port of a second optical detector 12 is optically coupled to an output port of the FBG 15. Each of the optical detectors 11 and 12 has an electrical output port for outputting an electrical signal indicative of optical power coupled into the optical port of the detector. The electrical output ports of the optical detectors are connected to respective electrical input ports of processing means 18 by electrical interconnects 16 and 17 for communicating the electrical signals from the optical detectors to the processing means. The processing means 18 are capable of determining the OSNR from the electrical signals received from the detectors 11 and 12, and preferably comprise a microprocessor having a memory unit for storing pre-determined calibration data.

The optical coupler 8 can be for example a commercially available bidirectional fused-fiber four-port optical coupler. In that case, each port of the fiber-optic coupler 8 is coupled to two opposing optical ports of the coupler. For example, an input first optical port 1 is coupled to a second optical port 2 and to the third optical port 3, and the third optical port 3 is coupled to the forth optical port 4 and the first optical port 1. For instant invention however only optical coupling between the ports 1 and 3, and the ports 3 and 4 is required.

Further important features of the invention will become clear from considering operation of the apparatus for measuring the OSNR in accordance with the preferred embodiment.

In operation, a lightwave carrying a signal-bearing optical channel propagates in an optical fiber 10 and enters the input optical port 1 of the coupler 8, which is optically connected to an output end of the fiber 10. A portion of the lightwave is coupled to the third port 3 of the optical coupler and exits therefrom into the input port of the FBG 15, which is optically connected to the third port 3 of the coupler 8. The signal-bearing optical channel has a signal component and a noise component.

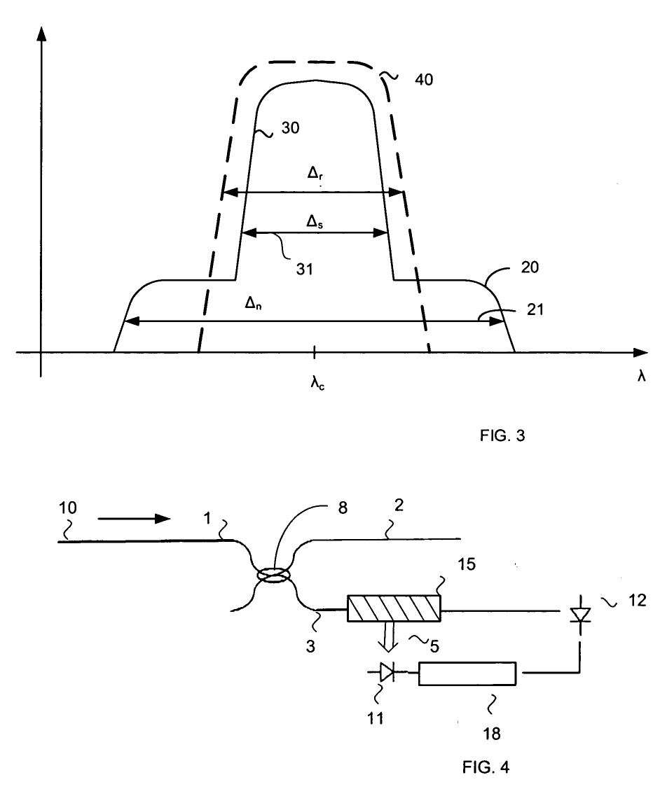

With reference to FIG. 3, in a wavelength domain the signal component 30 of the optical channel occupies a signal wavelength band 31 centered at a center channel wavelength λ_{c}. Said signal wavelength band 31 has a bandwidth Δₛ determined by an information capacity of the channel, or, for digitally modulated channels, by the channel bit rate. The bandwidth Δₛ is hereafter referred to as a signal bandwidth.

The noise component 20 occupies a noise spectral band 21, which is wider than the signal spectral band and has a wavelength bandwidth Δₙ hereafter referred to as a noise bandwidth. In a typical WDM optical communication link, the noise component is primarily due to amplified spontaneous emission (ASE) from erbium-doped fiber amplifiers (EDFA), which spectral width is typically about 35-45 nm and greatly exceeds Δₛ. In a typical application of the invention in accordance with a preferred embodiment, the apparatus for measuring the OSNR shown in FIG. 2 is disposed after an optical demultiplexer, in which case the noise bandwidth Δₙ is determined by a passband of the demultiplexer and is considerably smaller than the full ASE bandwidth.

The FBG 15 has a reflection band 40 centered substantially about λ_{c} and a reflection bandwidth Δᵣ which satisfies a condition (2):
Δₛ≦Δᵣ<Δn (2)

The FBG 15 reflects the signal component back towards the third port 3 of the coupler 8 which is optically coupled to the forth port 4, and the reflected signal component is therefore coupled into the first optical detector 11. A portion of the noise component which in wavelength domain lies outside the FBG reflection band 40 is transmitted through the output port of the FBG and coupled into the input port of the optical detector 12. The FBG reflection bandwidth is selected according to condition (2) so that a fraction of the signal component transmitted through the FBG 15 is negligible compared to the transmitted noise component, and a fraction of the noise component which is reflected by the FBG is negligible compared to the reflected signal component. Therefore, an electrical signal S generated by the first optical detector 11 in response to receiving reflected radiation is indicative of, and typically proportional to, the signal component of the optical channel, while an electrical signal N generated by the second optical detector 12 in response to receiving transmitted radiation is indicative of, and typically proportional to, the noise component of the optical channel.

The electrical signals S and N are communicated to the processing means 18 through electrical interconnects 16 and 17. The processing means 18 comprise stored pre-determined calibration data, for example in a form of a look-up table, allowing the processing means 18 to determine the OSNR for the optical channel from the electrical signals S and N, and therefore enabling real-time monitoring of the OSNR and the optical channel power. In other embodiments, the processing means 18 can determine OSNR by calculating a suitably scaled ratio of the electrical signals S and N, wherein the scaling is provided by the calibration data.

The signal component of the optical channel can exceed the noise component of said channel by as much as 30 dB and more; therefore many prior art OSNR monitoring solutions required optical detectors with a high dynamic range. However, in the aforedescribed solution of instant invention the noise component and the signal component are measured by different optical detectors, thereby removing the requirement of having high dynamic range detectors. Instead, the optical detector 11 for measuring the signal component can be a low gain photodiode, while the optical detector 12 for measuring the noise component can be a high gain photodiode.

The aforedescribed preferred embodiment of the apparatus for measuring the OSNR has a further advantage of being completely passive, very simple, compact and relatively inexpensive to manufacture. It does not require any tunable or moving parts or any feedback control unit; thereby enabling very short sampling time for OSNR monitoring. Performance of the apparatus does not depend on polarization of the lightwave, which can significantly reduce an OSNR measurement error caused by polarization mode dispersion.

Other embodiments of instant invention which incorporate its main features are possible. With reference to FIG. 4, in another less preferred embodiment the FBG grating 15 can be a blazed grating deflecting the signal component out of the fiber rather than reflecting it back. The deflected signal component 5 is then coupled into the optical detector 11, said optical detector 11 producing thereby an electrical signal S indicative of the signal component.

In another embodiment, the FBG 15 can be a tunable FBG having a reflection band with a center wavelength that can be tuned to match center wavelengths of a plurality of optical channels. The calibration data in this case can include data describing possible changing of the reflection bandwidth due to FBG tuning.

In another aspect of instant invention, a method of determining the OSNR for an optical channel radiation is thereby provided. The method comprises the following steps;
a) providing a fiber grating disposed to receive the optical channel radiation for reflecting or deflecting the signal component out of the fiber grating to form a tapped radiation, and for transmitting at least a portion of the noise component therethrough to form a transmitted radiation;
b) providing a first optical detector disposed to receive at least a fraction of the tapped radiation for producing a first electrical signal indicative of the signal component;
c) providing a second optical detector disposed to receive at least a fraction of the transmitted radiation for producing a second electrical signal indicative of the noise component;
d) providing optical coupling means for coupling the at least a fraction of the tapped radiation into the first optical detector;
e) providing processing means disposed to receive the first electrical signal indicative of the signal component and the second electrical signal indicative of the noise component for determining the optical signal to noise ratio;
f) launching a portion of the optical channel radiation into the fiber grating;
g) determining the optical signal to noise ratio from the first information signal and the second information signal using the processing means.

In some embodiments, the apparatus of instant invention is used in a transmission mode, wherein only a small portion, typically 1-10%, of the lightwave propagating in the optical fiber 10 is coupled into the FBG 15 by the coupler 8 for measuring the OSNR, while most of the lightwave is transmitted through the coupler 8 to the forth output port 4. In these embodiments, the first port 1 and the second port 2 of the coupler 8 are respectively an input port and an output port of the apparatus of measuring the OSNR according to instant invention, and the optical channel is passed through the apparatus with a small attenuation, which can be less than 1 dB.

In another embodiment, the apparatus of the preferred embodiment shown in FIG. 2 can be used as a terminal device, wherein the first port 1 is a single optical port of the apparatus and serves as an input optical port. In these embodiments, the FBG should be preferably connected to an output port of the coupler, which is strongly coupled to its input port 1, so that most of the optical channel entering the coupler 8 is coupled into the FBG.

In another aspect of instant invention, the aforedescribed apparatus for measuring the OSNR of an optical channel can be used to measure and monitor the OSNR for a plurality of optical channels of a WDM signal.

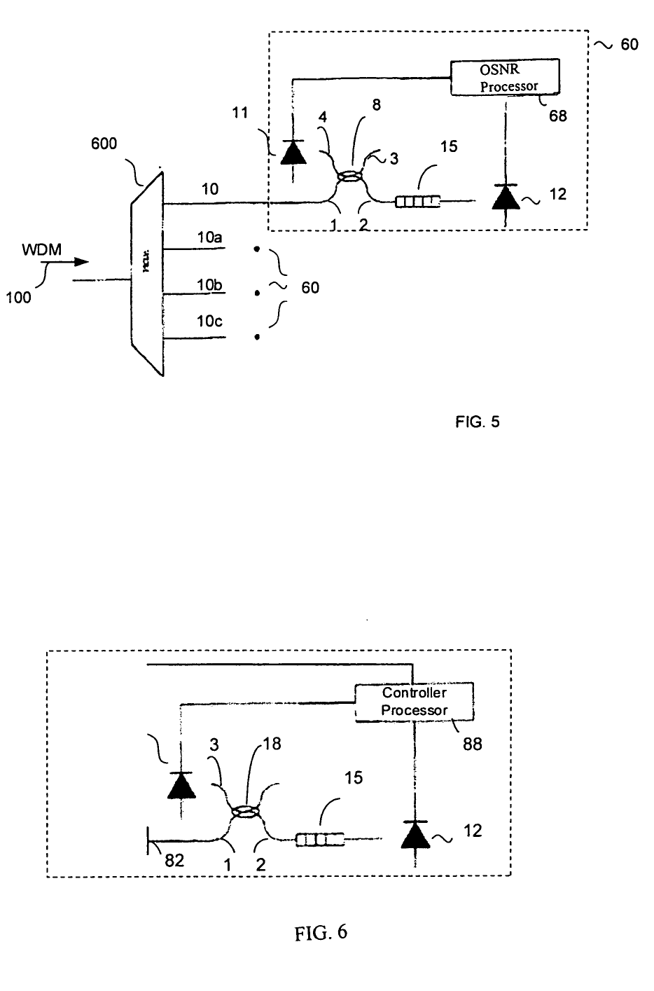

With reference to FIG. 5, a WDM demultiplexer 600 is provided having an input fiber-optic port 100 wherein the WDM signal is launched, and a plurality of output fiber-optic ports 10, 10a, 10b 10c etc. wherefrom demultiplexed optical channels are outputted. In a preferred embodiment of this aspect of the invention, each fiber-optic output port carries a single-channel lightwave which can be launched into the input port of an apparatus for measuring the OSNR, said apparatus being almost identical to the apparatus in accordance with the aforedescribed first embodiment of present invention shown in FIG. 2.

In an exemplary embodiment of instant aspect of the invention shown in FIG. 5, the output fiber-optic port 10 of the demultiplexer 600 provided for outputting a demultiplexed optical channel having a central wavelength λc is connected to the input port 1 of the coupler 8, which serves also as an optical port of an apparatus 60 for measuring the OSNR of the demultiplexed optical channel. The apparatus 60, hereafter referred to as a channel OSNR monitor, comprises the coupler 8, the FBG 15, and the optical detectors 11 and 12. The FBG 15 having a reflection band centered substantially about □_{c} is connected to an output port 2 of the coupler 8 whereto a substantial portion of the optical channel entering the input port 1 of the coupler 18 is coupled. The first optical detector 11 is connected to port 4 of the coupler for detecting the signal component of the optical channel. The second optical detector 12 is connected to the output port of the FBG for detecting the noise component of the optical channel transmitted through the FBG.

When a WDM signal comprising the optical channel is launched into the input port of the demultiplexer 600, a lightwave carrying the channel is outputted through the output fiber-optic port 10 and is coupled into the FBG 15 by a coupler 8. The signal component of the optical channel is reflected by the FBG and detected by the optical detector 11, while the noise component of the channel is transmitted though the FBG and is detected by the second optical detector 12. Electrical signals outputted by said detectors 11 and 12 are communicated to a processor 68 for determining the OSNR for the optical channel.

Similarly, some or all of the other output ports of the demultiplexer 600 can be connected to their respective channel OSNR monitors which can be identical to the channel OSNR monitor 60, with only the FBG reflection band varying from one said monitor to another according to a central wavelength of their respective channels.

In some embodiments of this aspect of the invention, each of the channel monitors can comprise a microprocessors for determining the OSNR for the channel. In other embodiments, a common microprocessor can be provided for determining the signal to noise ratios for the plurality of demutiplexed channels.

In some embodiments, the aforedescribed method and apparatus of instant invention can be used to monitor optical power of the signal component. In optical networks, knowledge of the optical power Ps of the signal component of a channel separately from the noise component of the channel within the signal bandwidth may be required. However, measuring a total power of an optical channel, for example by using a photodiode coupled to an output port of a demultiplexer, may not be an adequate solution when the channel OSNR is low and the noise component contributes a significant part in the total channel power. In this case, the processing means 18 or 68 can be used to determine the optical power of the signal component of the channel from the electrical signals S and N. This can be accomplished, for example, by subtracting an appropriately scaled noise component from the signal component, as described by equation (3)
Ps=k₁*(S−k₂*N) (3)
wherein k₁ is a pre-determined calibration parameter which can account for detector sensitivity, optical losses in the optical coupler 8 etc, and k₂ is a pre-determined calibration parameter which can account for example for the noise bandwidth relative to the reflection bandwidth of the FBG and for possible non-equality of the detector sensitivity of the detectors 11 and 12.

In another embodiment, instant invention can be used for measuring the OSNR of a plurality of optical channels of a WDM signal while providing channel equalization.

With reference to FIG. 6, a WDM signal comprising a plurality of optical channels is launched in a first input port 71 of an optical circulator 70. A second optical port of the circulator 72 is optically connected with a WDM port of a multiplexer/demultiplexer 600. The multiplexer/demultiplexer 600 has a plurality of channel input/output ports 10, 10a, 10b, 10c etc for outputting demultiplexed optical channels therethrough, and for inputting a plurality of optical channels for multiplexing into an output WDM signal. The multiplexer/demultiplexer 600 can be a commercially available multiplexer/demultiplexer based for example on thin film filters or on an array waveguide grating. Each of the channel input/output ports is connected to an input/output port of a channel equalizing and OSNR monitoring module. These modules are labeled in FIG. 6 with reference numerals “80”, “80a”, “80b”, and “80c”. FIG. 6 shows a diagram of an exemplary embodiment of the channel equalizing and OSNR monitoring module 80. The channel equalizing and OSNR monitoring module 80 substantially comprises a variable optical attenuator (VOA) 85 optically connected in series with OSNR and channel power monitoring means, wherein constituent parts of said OSNR and channel power monitoring means and their arrangement are similar to the constituent parts of the OSNR monitor 60 and their arrangement, but comprise processing means 88 having an additional functionality of controlling the VOA 85.

The VOA 85 has a first optical port 81 which serves as an input/output optical port of the channel equalizing and OSNR monitoring module 80 and is optically connected to the channel output port 10 of the multiplexer/demultiplexer 600. A second optical port 82 of the VOA 85 is optically connected to the first optical port of the coupler 8. The input port of the FBG 15 is connected to the second optical port 2 of the coupler 8. An optical port of the optical detector 11 is connected to the third optical port 3 of the coupler 8 for detecting a small portion of the signal component of the optical channel reflected from the FBG and coupled into the port 3 of the coupler 8. An optical port of the optical detector 12 is connected to the output port of the FBG 15 for detecting the noise component of the optical channel transmitted through the FBG 15. Processing means 88 have two input electrical ports for receiving electrical signals S and N from the detectors 11 and 12 indicative of the signal and noise components of the optical channel respectively. The processing means 88 have also an output electrical port electrically connected to an input electrical port 83 of the VOA for controlling optical attenuation of the VOA. The processing means 88 are also capable of receiving information from other channel equalizing and OSNR monitoring modules connected to other channel output ports of the multiplexer/demultiplexer 600.

In operation, the WDM signal launched into the input port 71 of the circulator 70 is coupled into the multiplexer/demultiplexer 600 through the circulator port 72 and the input WDM port of the multiplexer/demultiplexer for demultiplexing into individual channels or groups of channels. Further operation of this embodiment will be explained assuming for clarity that the plurality of optical channels of the WDM signal comprises at least an optical channel which is transmitted through the channel input/output port 10 of the multiplexer/demultiplexer. This channel is referred to hereafter as an optical channel c10, while optical channels transmitted through the channel input/output ports 10a, 10b etc of the multiplexer/demultiplexer 600 are hereafter referred to as channels c10a, c10b etc. respectively.

The optical channel c10 of the WDM signal is coupled into the input port of the VOA 85 and after passing therethrough is connected into the input port of the FBG 15. The signal portion of the optical channel, said portion lying in a spectral domain within the reflection band of the FBG 15, is reflected by the FBG 15, and a major fraction of said signal portion is then coupled by the coupler 8 back into the second optical port 82 of the VOA. A minor fraction of the signal portion of the optical channel is coupled into the first optical detector 11, which generates the electrical signal S indicative of the signal portion of the optical channel c10. A portion of the noise component of the channel is transmitted through the FBG 15 and coupled into the second optical detector 12, which generates the electrical signal N indicative of the noise component of the optical channel c10. The processing means 88 receive the electrical signals S and N and process the information to determine the channel OSNR and/or the optical power of the signal component. The processing means 88 can also receive information from other channel equalizing and OSNR monitoring modules 80a, 80b etc. about the signal and noise components of the other channels c10a, c10b etc from the plurality of optical channels of the WDM signal. The processing means 88 then use the received information to determine a required attenuation setting for the VOA 85 for equalizing the optical channel c10 with the other optical channels. The apparatus can be used to equalize either the total optical channel power or the optical power of only the signal component as herein described.

An appropriately attenuated channel c10 is then coupled into the input/output port of the multiplexer/demultiplexer 600, wherein it is multiplexed with other appropriately attenuated channels c10a, c10b etc to form a channel-equalized WDM signal. The channel-equalized WDM signal is then coupled into the optical circulator 70 and is outputted through a third port 73 of the circulator forming thereby a channel-equalized output WDM signal.

Of course numerous other embodiments may be envisaged without departing from the spirit and scope of the invention.

1. An apparatus for measuring an optical signal to noise ratio (OSNR) for an optical channel radiation having a central wavelength λc and having a noise component having a noise bandwidth and a signal component having a signal bandwidth, said apparatus comprising:
a spectrally selective reflecting element having a reflecting bandwidth disposed to receive the optical channel radiation for reflecting at least a portion of the signal component to form reflected radiation, and for transmitting at least a portion of the noise component to form transmitted radiation;
a first optical detector disposed to receive at least a fraction of the reflected radiation for producing a first information signal indicative of the signal component;
a second optical detector disposed to receive the transmitted radiation for producing a second information signal indicative of the noise component,
optical coupling means for coupling the optical channel radiation into the spectrally-selective reflecting element, and for coupling at least a fraction of the reflected radiation into the first optical detector;
processing means disposed to receive the first information signal indicative of the signal component and the second information signal indicative of the noise component for determining the optical signal to noise ratio.

2. An apparatus for measuring the optical signal to noise ratio as defined in claim. 1, wherein the spectrally-selective reflecting element is a fiber Bragg grating (FBG).

3. An apparatus for measuring the optical signal to noise ratio as defined in claim 2, wherein the optical coupling means is a bidirectional optical coupler.

4. An apparatus for measuring the optical signal to noise ratio as defined in claim 2, wherein the first information signal and the second information signals are electrical signals.

5. An apparatus for measuring the optical signal to noise ratio as defined in claim 4, wherein the processing means comprise a suitably programmed microprocessor for determining the OSNR.

6. An apparatus for measuring the optical signal to noise ratio as defined in claim 5, wherein the processing means include a look-up table for determining the OSNR from the first information signal and the second information signal.

7. An apparatus for measuring the optical signal to noise ratio as defined in claim 2, wherein the first optical detector is for monitoring optical power of the signal component.

8. An apparatus for measuring the optical signal to noise ratio as defined in claim 2, wherein the second optical detector is for monitoring optical power of the noise component.

9. An apparatus for measuring the optical signal to noise ratio as defined in claim 2, said apparatus operable for real-time monitoring of at least one of: the OSNR, an optical power of the signal component, an optical power of the noise component.

10. An apparatus for measuring the optical signal to noise ratio as defined in claim 2, wherein the fiber Bragg grating has a reflection band, and wherein the reflection band is centered substantially about λc.

11. An apparatus for measuring the optical signal to noise ratio as defined in claim 10, wherein the noise bandwidth is greater than the signal bandwidth.

12. An apparatus for measuring the optical signal to noise ratio as defined in claim 11, wherein the reflecting bandwidth is at least as large as the signal bandwidth and smaller than the noise bandwidth.

13. An apparatus for measuring the optical signal to noise ratio as defined in claim 2, wherein a substantial portion of the noise component is due to amplified spontaneous emission (ASE).

14. A method of determining an optical signal to noise ratio for an optical channel radiation having a central wavelength λc and having a noise component having a noise wavelength band and a signal component having a signal wavelength band wherein the signal wavelength band is narrower than the noise wavelength band, said method comprising steps of:
providing a fiber grating disposed to receive the optical channel radiation for reflecting or deflecting the signal component out of the fiber grating to form a tapped radiation, and for transmitting at least a portion of the noise component therethrough to form a transmitted radiation;
providing a first optical detector disposed to receive at least a fraction of the tapped radiation for producing a first electrical signal indicative of the signal component;
providing a second optical detector disposed to receive at least a fraction of the transmitted radiation for producing a second electrical signal indicative of the noise component;
providing optical coupling means for coupling the at least a fraction of the tapped radiation into the first optical detector;
providing processing means disposed to receive the first electrical signal indicative of the signal component and the second electrical signal indicative of the noise component for determining the optical signal to noise ratio;
launching a portion of the optical channel radiation into the fiber grating;
determining the optical signal to noise ratio from the first information signal and the second information signal using the processing means.

15. A method of determining the optical signal to noise ratio for an optical channel radiation as defined in claim 14, wherein the step of determining includes a step of calculating a suitable scaled ratio of the first electrical signal and the second electrical signal.

16. A method of determining the optical signal to noise ratio for an optical channel radiation as defined in claim 14, further comprising a step of providing a look-up table for determining the optical signal to noise ratio from the first information signal and the second information signal.

17. A method of determining an optical signal to noise ratio for an optical channel of a WDM signal comprising a plurality of optical channels, said optical channel having a central wavelength λc and having a noise component having a noise wavelength band and a signal component having a signal wavelength band wherein the signal wavelength band is narrower than the noise wavelength band, said method comprising steps of:
providing a wavelength de-multiplexer disposed to receive a fraction of the WDM signal for wavelength de-multiplexing of at least the optical channel from the plurality of optical channels;
determining the optical signal to noise ratio for the optical channel using the method of determining the optical signal to noise ratio as defined in claim 14.

18. An apparatus for measuring an optical signal to noise ratio (OSNR) for an optical channel radiation having a central wavelength λc and having a noise component having a noise bandwidth and a signal component having a signal bandwidth, said apparatus consisting of a fiber Bragg grating having a reflecting bandwidth disposed to receive the optical channel radiation for reflecting at least a portion of the signal component to form reflected radiation, and for transmitting at least a portion of the noise component to form transmitted radiation;
a first optical detector disposed to receive at least a fraction of the reflected radiation for producing a first information signal indicative of the signal component;
a second optical detector disposed to receive the transmitted radiation for producing a second information signal indicative of the noise component;
optical coupling means for coupling the optical channel radiation into the spectrally-selective reflecting element, for coupling at least a fraction of the reflected radiation into the first optical detector, and for coupling the transmitted radiation into the second optical detector;
processing means disposed to receive the first information signal indicative of the signal component and the second information signal indicative of the noise component for determining the optical signal to noise ratio.

19. An apparatus for measuring the optical signal to noise ratio as defined in claim 2, wherein the fiber Bragg grating is a tunable fiber Bragg grating operable to reflect a signal component for a plurality of optical channels at different instances of time.

20. An apparatus for measuring the optical signal to noise ratio as defined in claim 2, wherein the processing means are for determining the optical power of the signal component from the first information signal and the second information signal using predetermined calibration data.
